(19) United States
(12) Patent Application Publication
(10) Pub. No.: US 2018/0143698 A1
(43) Pub. Date: May 24, 2018

(54) KEYBOARD

(71) Applicant: PRIMAX ELECTRONICS LTD., Taipei (TW)

(72) Inventors: Yi-Shu Lee, Taipei (TW); Lei-Lung Tsai, Taipei (TW)

(21) Appl. No.: 15/397,484

(22) Filed: Jan. 3, 2017

(30) Foreign Application Priority Data
Nov. 18, 2016 (TW) 105137891

(51) Int. Cl. G06F 3/02; G06F 3/023

(52) U.S. Cl. CPC G06F 3/0221; G06F 3/0238

(57) ABSTRACT

A keyboard includes a base plate, a switch circuit board, plural swinging-type key structures, a light-emitting element, a light guide plate and a covering member. The light-emitting element emits a light beam. The plural swinging-type key structures are disposed on the switch circuit board. When one of the swinging-type key structures is pressed, the switch circuit board is triggered to generate a key signal. The light guide plate comprises plural light guide sub-plates. The light guide sub-plates are disposed on the corresponding swinging-type key structures. The covering member covers the base plate and the light guide plate. The covering member has a light-transmissible region. The light beam from the light-emitting element passes through the light-transmissible region. Consequently, the key structure is illuminated.

### FIELD OF THE INVENTION

The present invention relates to a keyboard, and more particularly to a slim-type keyboard.

### BACKGROUND OF THE INVENTION

Generally, the widely-used peripheral input device of a computer system includes for example a mouse, a keyboard, a trackball, or the like. Via the keyboard, characters or symbols can be directly inputted into the computer system. As a consequence, most users and most manufacturers of input devices pay attention to the development of keyboards. As known, a keyboard with scissors-type connecting elements is one of the widely-used keyboards.

Hereinafter, a keyboard with scissors-type connecting elements will be illustrated with reference to FIG. 1. FIG. 1 is a schematic side cross-sectional view illustrating a key structure of a conventional keyboard. As shown in FIG. 1, the conventional key structure 1 comprises a keycap 11, a scissors-type connecting element 12, a rubbery elastomer 13, a membrane switch circuit member 14 and a base plate 15. The keycap 11, the scissors-type connecting element 12, the rubbery elastomer 13 and the membrane switch circuit member 14 are supported by the base plate 15. The scissors-type connecting element 12 is used for connecting the base plate 15 and the keycap 11.

The scissors-type connecting element 12 is arranged between the base plate 15 and the keycap 11, and the base plate 15 and the keycap 11 are connected with each other through the scissors-type connecting element 12. The scissors-type connecting element 12 comprises a first frame 121 and a second frame 122. A first end of the first frame 121 is connected with the keycap 11. A second end of the first frame 121 is connected with the base plate 15. The rubbery elastomer 13 is enclosed by the scissors-type connecting element 12. The membrane switch circuit member 14 comprises plural key intersections (not shown). When one of the plural key intersections is triggered, a corresponding key signal is generated. The rubbery elastomer 13 is disposed on the membrane switch circuit member 14. Each rubbery elastomer 13 is aligned with a corresponding key intersection. When the rubbery elastomer 13 is pressed, the rubbery elastomer 13 is subjected to deformation to push the corresponding key intersection of the membrane switch circuit member 14. Consequently, the corresponding key signal is generated.

The operations of the conventional key structure 1 in response to the pressing action of the user will be illustrated as follows. Please refer to FIG. 1 again. When the keycap 11 is pressed, the keycap 11 is moved downwardly to push the scissors-type connecting element 12 in response to the pressing force. As the keycap 11 is moved downwardly relative to the base plate 15, the keycap 11 pushes the corresponding rubbery elastomer 13. At the same time, the rubbery elastomer 13 is subjected to deformation to push the membrane switch circuit member 14 and trigger the corresponding key intersection of the membrane switch circuit member 14. Consequently, the membrane switch circuit member 14 generates a corresponding key signal. When the keycap 11 is no longer pressed by the user, no external force is applied to the keycap 11 and the rubbery elastomer 13 is no longer pushed by the keycap 11. In response to the elasticity of the rubbery elastomer 13, the rubbery elastomer 13 is restored to its original shape to provide an upward elastic restoring force. Consequently, the keycap 11 is returned to its original position where it is not pressed. The structures and the operations of the conventional key structure have been mentioned as above.

With increasing development of science and technology, the demand on a slim-type keyboard is gradually increased. Consequently, the manufacturers of keyboard make efforts in developing slimmer key structures. However, since the scissors-type connecting element for connecting the keycap and the base plate is essential, the reduction of the thickness of the key structure is still unsatisfied. Moreover, since the thickness of the key structure is decreased, the structural strength of the key structure is reduced and the key structure is readily damaged.

Therefore, there is a need of providing a keyboard with slimness and enhanced structural strength.

### SUMMARY OF THE INVENTION

The present invention provides a keyboard with slimness and enhanced structural strength.

In accordance with an aspect of the present invention, there is provided a keyboard. The keyboard includes a base plate, a switch circuit board, plural swinging-type key structures, a light-emitting element, a light guide plate and a covering member. The switch circuit board is disposed on the base plate. When the switch circuit board is triggered, a key signal is generated. The plural swinging-type key structures are disposed over the switch circuit board. The plural swinging-type key structures are swingable relative to the switch circuit board to trigger the switch circuit board. The light-emitting element generates a light beam. The light guide plate is disposed on the plural swinging-type key structures and guides the light beam. The light guide plate includes plural light guide sub-plates corresponding to the plural swinging-type key structures, respectively. The plural light guide sub-plates are disposed on the corresponding plural swinging-type key structures and swung with the corresponding plural swinging-type key structures. The covering member covers the base plate, the switch circuit board, the plural swinging-type key structures, the light-emitting element and the light guide plate. The covering member includes plural light-transmissible regions corresponding to the plural swinging-type key structures. The light beam passes through the plural light-transmissible regions. Consequently, the keyboard is illuminated.

From the above descriptions, the present invention provides a keyboard. The keyboard comprises swinging-type key structures. The swinging-type key structure is equipped with a supporting element and a metallic pressing plate to replace the keycap and the scissors-type connecting element of the conventional key structure. Moreover, the swinging-type key structure is equipped with a metallic elastic element to replace the rubbery elastomer of the conventional key structure. Since the overall thickness of the supporting element and the metallic pressing plate is much smaller than the overall thickness of the keycap and the scissors-type connecting element, the keyboard of the present invention is thinner than the conventional keyboard. That is, the thickness of the keyboard of the present invention is largely reduced when compared with the conventional keyboard. Moreover, since the metallic pressing plate of the key structure of the present invention is made of the metallic material, the structural strength of the metallic pressing plate is larger than the conventional key structure that is made of the plastic material. In addition, the metallic pressing plate is not readily damaged. The keyboard of the present invention is further equipped with the light guide plate over the metallic pressing plate. The light guide plate comprises plural light guide sub-plates that can be swung independently. The light beam is guided to pass through the light-transmissible regions by the light guide sub-plates. Consequently, the keyboard has the luminous efficacy.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic side cross-sectional view illustrating a key structure of a conventional keyboard;

FIG. 2 is a schematic perspective view illustrating a portion of a keyboard according to an embodiment of the present invention;

FIG. 3 is a schematic exploded view illustrating a portion of the keyboard according to the embodiment of the present invention; and

FIG. 4 is a schematic side view illustrating a portion of the key board according to the embodiment of the present invention.

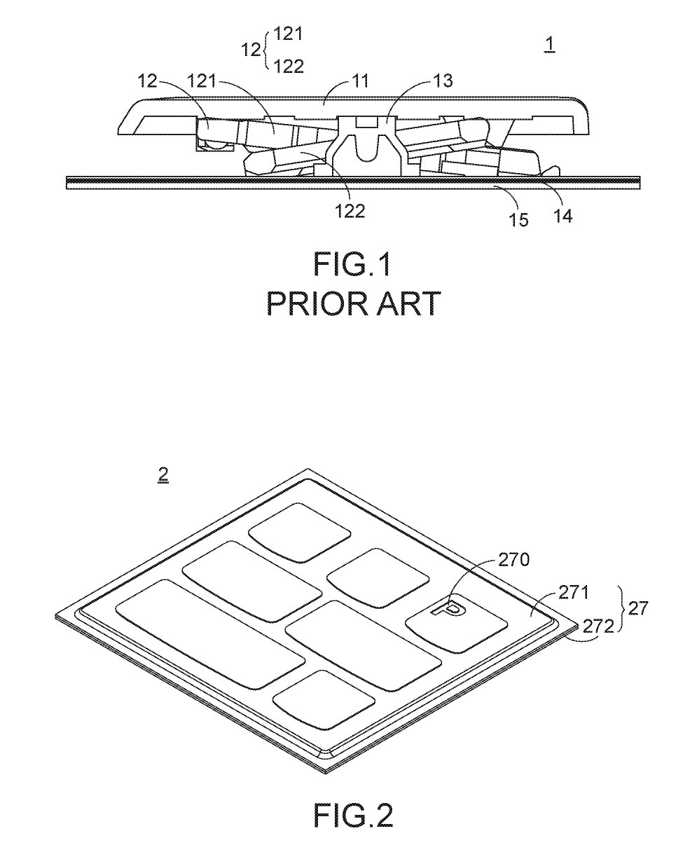

### DETAILED DESCRIPTION OF THE PREFERRED EMBODIMENT

For solving the drawbacks of the conventional technologies, the present invention provides a keyboard with enhanced structural strength and slim appearance.

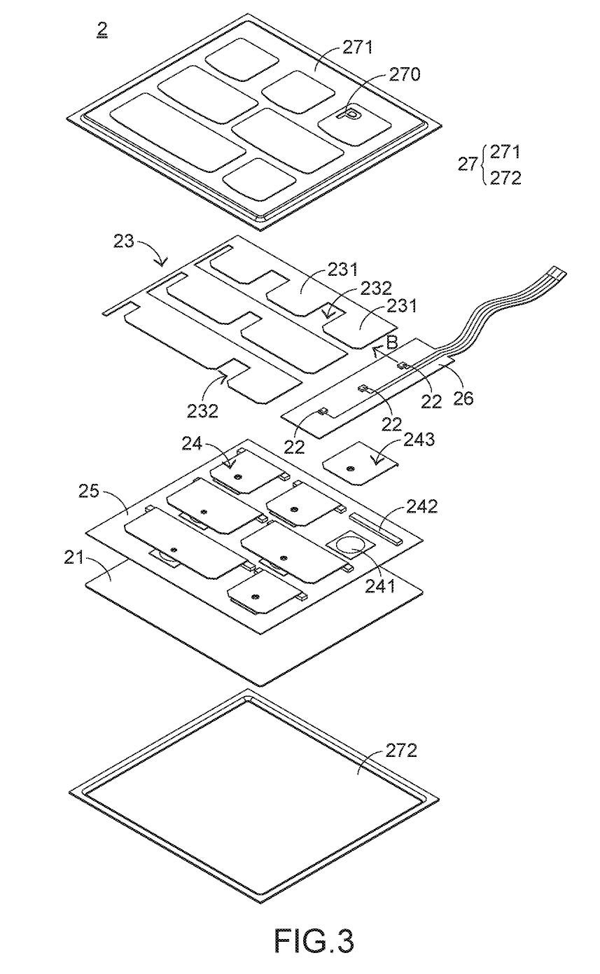

FIG. 2 is a schematic perspective view illustrating a portion of a keyboard according to an embodiment of the present invention. FIG. 3 is a schematic exploded view illustrating a portion of the keyboard according to the embodiment of the present invention. As shown in FIGS. 2 and 3, the keyboard 2 comprises a base plate 21, plural light-emitting elements 22, a light guide plate 23, plural swinging-type key structures 24, a switch circuit board 25, a power-supplying circuit board 26 and a covering member 27. The switch circuit board 25 is disposed on the base plate 21. When the switch circuit board 25 is pressed by the user, the switch circuit board 25 is triggered to generate a key signal. The plural swinging-type key structures 24 are disposed over the switch circuit board 25. The plural swinging-type key structures 24 can be swung relative to the base plate 21 to trigger the switch circuit board 25. The power-supplying circuit board 26 is disposed over the switch circuit board 25, and located beside some of the swinging-type key structures 24. As shown in FIG. 3, the swinging-type key structures 24 are on the left side of the power-supplying circuit board 26. It is noted that some other swinging-type key structures 24 may be on the right side of the power-supplying circuit board 26. The plural light-emitting elements 22 are electrically connected with and supported by the power-supplying circuit board 26. The power-supplying circuit board 26 provides electric power to the plural light-emitting elements 22. The plural light-emitting element 22 emits a light beam B. In an embodiment, the light-emitting elements 22 are light emitting diodes, the power-supplying circuit board 26 is a flexible printed circuit (FPC), and the switch circuit board 25 is a membrane switch circuit board.

The base plate 21, the plural light-emitting elements 22, the light guide plate 23, the plural swinging-type key structures 24, the switch circuit board 25 and the power-supplying circuit board 26 are covered by the the covering member 27. In this embodiment, the covering member 27 comprises an upper covering layer 271 and a lower covering layer 272. The upper covering layer 271 is located over the light guide plate 23 light guide plate 23 to cover the light guide plate 23. Moreover, the upper covering layer 271 comprises plural light-transmissible regions 270 corresponding to the plural swinging-type key structures 24. After the light beam B is guided to pass through the plural light-transmissible regions 270, the keyboard 2 has the luminous efficacy. The lower covering layer 272 is located under the base plate 21 to cover a bottom surface of the base plate 21. After the lower covering layer 272 and the upper covering layer 271 are combined together to form the covering member 27, the above components are covered by the covering member 27.

That is, the light guide plate 23, the plural swinging-type key structures 24, the switch circuit board 25, the plural light-emitting elements 22, the power-supplying circuit board 26 and the base plate 21 are covered by the upper covering layer 271 and the lower covering layer 272 from a top side and a bottom side, respectively. Moreover, the region of the keyboard 2 to be contacted by the user's finger is the upper covering layer 271. In this embodiment, the profile of the light-transmissible region 270 matches the profile of the corresponding character symbol of the key structure 24. For example, the key structure 24 is the key “P” of the keyboard 2. The profile of the light-transmissible region 270 matches the profile of the character symbol “P”. In an embodiment, the light-transmissible region 270 is a hollow structure that is formed by performing a laser-engraving process to remove a portion of the upper covering layer 271 (i.e., the portion of the upper covering layer 271 corresponding to character symbol). The upper covering layer 271 is made of synthetic feather and foam. For example, the synthetic feather is polyurethane (PU) feather. In this embodiment, portion of the upper covering layer 271 corresponding to the swinging-type key structures 24 is made of the synthetic feather, and the other portion of the upper covering layer 271 is made of foam.

The light guide plate 23 is disposed on the plural swinging-type key structures 24. The light guide plate 23 is used for guiding the light beam B. In this embodiment, the light guide plate 23 comprises plural light guide sub-plates 231. Each light guide sub-plate 231 is aligned with one swinging-type key structure 24, and disposed on the corresponding swinging-type key structure 24. Consequently, the light guide sub-plate 231 is swung relative to the corresponding swinging-type key structure 24. Moreover, the light guide sub-plates 231 comprises light-guiding structures (not shown) corresponding to the light-transmissible regions 270. For example, the light-guiding structures are microstructures or light-guiding dots. After the light beam B is projected on the light-guiding structures, the direction of the light beam B is changed. Consequently, the light beam B is directed to the light-transmissible regions 270. Moreover, there is a vacant space 232 between every two adjacent light guide sub-plates 231. That is, every two adjacent light guide sub-plates 231 are separated from each other by the vacant space 232. Consequently, these light guide sub-plates 231 can be swung independently. When one of the plural swinging-type key structures 24 is pressed, the pressed swinging-type key structure 24 is not interfered with the adjacent swinging-type key structures 24 because the light guide sub-plates 231 are swung independently. In another embodiment, the light guide sub-plates are fixed on the corresponding swinging-type key structures, and the light guide sub-plates and the corresponding swinging-type key structures are connected with each other.

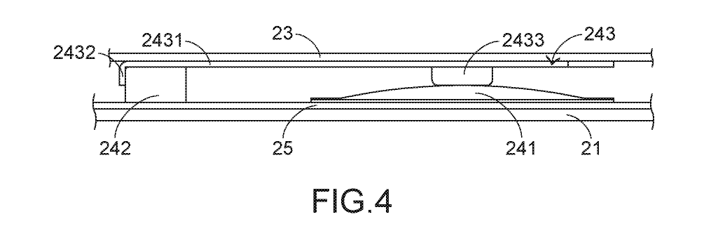

Hereinafter, the constituents of the swinging-type key structure 24 will be described with reference to FIGS. 3 and 4. FIG. 4 is a schematic side view illustrating a portion of the key board according to the embodiment of the present invention. For succinctness, only one swinging-type key structure 24 is shown in FIG. 4. The swinging-type key structure 24 comprises a metallic elastic element 241, a supporting element 242 and a metallic pressing plate 243. The metallic elastic element 241 is disposed on a top surface of the switch circuit board 25 and aligned with the corresponding key intersection (not shown) of the switch circuit board 25. When the metallic elastic element 241 is pressed by the metallic pressing plate 243, the metallic elastic element 241 is subjected to deformation to trigger the corresponding key intersection of the switch circuit board 25. When the metallic elastic element 241 is restored from a deformed state to an original shape, the metallic elastic element 241 provides an elastic force to the metallic pressing plate 243. The supporting element 242 is disposed on the switch circuit board 25 and located beside the metallic elastic element 241. An edge of the metallic pressing plate 243 is fixed on the supporting element 242. Consequently, in response to an external force, the metallic pressing plate 243 is swung relative to the base plate 21. As the metallic pressing plate 243 is swung, the metallic elastic element 241 is pushed by the metallic pressing plate 243. In an embodiment, the metallic elastic element 241 is an elastic sheet that is made of a metallic material. For example, the metallic elastic element 241 is a metal dome. In this embodiment, the supporting element 242 is made of a soft material such as foam. The supporting element 242 is fixed on the switch circuit board 25 through an adhering means, a coupling means or a mechanic connecting means.

In an embodiment, the metallic pressing plate 243 comprises a main body 2431, a fixing part 2432 and a triggering part 2433. The main body 2431 is swung relative to the base plate 21. The fixing part 2432 is located at an edge of the metallic pressing plate 243 and connected with the main body 2431. Consequently, the fixing part 2432 is a bent structure relative to the main body 2431. An edge of the main body 2431 of the metallic pressing plate 243 is fixed on the supporting element 242 through the fixing part 2432. The triggering part 2433 is disposed on a bottom surface of the main body 2431. Moreover, the triggering part 2433 is contacted with the metallic elastic element 241.

In this embodiment, the fixing part 2432 and the triggering part 2433 are integrally formed with the main body 2431, and all of the main body 2431, the fixing part 2432 and the triggering part 2433 are made of a metallic material. Moreover, the fixing part 2432 is fixed on the supporting element 242 through an adhering means, a coupling means or a mechanic connecting means.

After the above components are combined together, the assembled swinging-type key structure 24 is shown in FIG. 4. The operations of the swinging-type key structure 24 in response to the pressing action of the user will be illustrated as follows. Firstly, the user's finger applies an external force to presses the upper covering layer 271. In response to the external force, the main body 2431 of the metallic pressing plate 243 is swung relative to the base plate 21. Consequently, the triggering part 2433 of the metallic pressing plate 243 is moved downwardly to push the metallic elastic element 241. Since the metallic elastic element 241 is subjected to deformation to press the switch circuit board 25, the corresponding key intersection of the switch circuit board 25 is triggered. Meanwhile, the switch circuit board 25 generates the corresponding key signal. When the user stops pressing the upper covering layer 271, the external force is no longer exerted on the main body 2431 of the metallic pressing plate 243. Meanwhile, the metallic elastic element 241 is not pushed by the triggering part 2433 of the metallic pressing plate 243. In response to the inherent elasticity, the metallic elastic element 241 is restored to its original shape from the deformation while providing an upward elastic force. In response to the upward elastic force, the main body 2431 of the metallic pressing plate 243 is pushed back to its original position where it is not pressed.

The following two aspects should be specially described. Firstly, in another embodiment, the covering member is made of light-transmissible thermoplastic polyurethane (TPU) material. Moreover, plural light-transmissible regions and plural opaque regions are formed on the upper covering layer of the covering member by a local negative printing process. The light beam cannot pass through the opaque regions. By the negative printing process, deep color ink or opaque ink is printed on the designated region of the upper covering layer. In an embodiment, the region aligned with the character symbol “P” is the light-transmissible region, and the region not aligned with the character symbol “P” is the opaque region. Consequently, the light beam is only allowed to pass through the region corresponding to the character symbol “P”.

Secondly, the supporting element 242 of the swinging-type key structure 24 is made of a soft material. When the side of the main body 2431 of the metallic pressing plate 243 close to the supporting element 242 is pressed by the user, the main body 2431 of the metallic pressing plate 243 is moved downwardly but not swung relative to the base plate 21 because the supporting element 242 is made of the soft material. Since the supporting element 242 is compressed by the main body 2431 of the metallic pressing plate 243, the supporting element 242 is subjected to deformation and the triggering part 2433 is moved downwardly to push the metallic elastic element 241. That is, the supporting element 242 must be made of the soft material. When any side or any corner of the main body 2431 of the metallic pressing plate 243 is pressed by the user, the main body 2431 of the metallic pressing plate 243 is swung or moved. Consequently, the triggering part 2433 of the metallic pressing plate 243 is moved downwardly to push the metallic elastic element 241. If the supporting element 242 is not made of the soft material, the metallic elastic element 241 is possibly not pushed by the triggering part 2433 when any side or any corner of the main body 2431 of the metallic pressing plate 243 is pressed by the user. Moreover, the supporting element 242 made of the soft material can provide enhanced tactile feel.

From the above descriptions, the present invention provides a keyboard. The keyboard comprises swinging-type key structures. The swinging-type key structure is equipped with a supporting element and a metallic pressing plate to replace the keycap and the scissors-type connecting element of the conventional key structure. Moreover, the swinging-type key structure is equipped with a metallic elastic element to replace the rubbery elastomer of the conventional key structure. Since the overall thickness of the supporting element and the metallic pressing plate is much smaller than the overall thickness of the keycap and the scissors-type connecting element, the keyboard of the present invention is thinner than the conventional keyboard. That is, the thickness of the keyboard of the present invention is largely reduced when compared with the conventional keyboard. Moreover, since the metallic pressing plate of the key structure of the present invention is made of the metallic material, the structural strength of the metallic pressing plate is larger than the conventional key structure that is made of the plastic material. In addition, the metallic pressing plate is not readily damaged. The keyboard of the present invention is further equipped with the light guide plate over the metallic pressing plate. The light guide plate comprises plural light guide sub-plates that can be swung independently. The light beam is guided to pass through the light-transmissible regions by the light guide sub-plates. Consequently, the keyboard has the luminous efficacy.

While the invention has been described in terms of what is presently considered to be the most practical and preferred embodiments, it is to be understood that the invention needs not be limited to the disclosed embodiments. On the contrary, it is intended to cover various modifications and similar arrangements included within the spirit and scope of the appended claims which are to be accorded with the broadest interpretation so as to encompass all modifications and similar structures.

What is claimed is:

1. A keyboard, comprising:
a base plate;
a switch circuit board disposed on the base plate, wherein when the switch circuit board is triggered, a key signal is generated;
plural swinging-type key structures disposed over the switch circuit board, wherein the plural swinging-type key structures are swingable relative to the switch circuit board to trigger the switch circuit board;
a light-emitting element generating a light beam;
a light guide plate disposed on the plural swinging-type key structures and guiding the light beam, wherein the light guide plate comprises plural light guide sub-plates corresponding to the plural swinging-type key structures, respectively, wherein the plural light guide sub-plates are disposed on the corresponding plural swinging-type key structures and swung with the corresponding plural swinging-type key structures; and
a covering member covering the base plate, the switch circuit board, the plural swinging-type key structures, the light-emitting element and the light guide plate, wherein the covering member comprises plural light-transmissible regions corresponding to the plural swinging-type key structures, wherein the light beam passes through the plural light-transmissible regions, so that the keyboard is illuminated.

2. The keyboard according to claim 1, wherein each of the swinging-type key structures comprises:
a metallic elastic element disposed on the switch circuit board, wherein the metallic elastic element is subjected to deformation to trigger the switch circuit board when the metallic elastic element is pressed, or the metallic elastic element provides an elastic force;
a supporting element disposed on the switch circuit board, and located beside the metallic elastic element; and
a metallic pressing plate, wherein an edge of the metallic pressing plate is fixed on the supporting element, and the metallic pressing plate is contacted with the corresponding light guide sub-plate, wherein the metallic pressing plate is swung relative to the base plate to push the metallic elastic element in response to an external force.

3. The keyboard according to claim 2, wherein the metallic pressing plate further comprises:
a main body swingable relative to the base plate and contacted with the corresponding light guide sub-plate;
a fixing part located at the edge of the metallic pressing plate and connected with the main body, wherein the fixing part is a bent structure relative to the main body, and the edge of the metallic pressing plate is fixed on the supporting element through the fixing part; and
a triggering part disposed on a bottom surface of the main body and contacted with the metallic elastic element.

4. The keyboard according to claim 3, wherein the fixing part is adhered and fixed on the supporting element, and the supporting element is adhered and fixed on the switch circuit board.

5. The keyboard according to claim 3, wherein the fixing part and the triggering part are integrally formed with the main body, and the main body, the fixing part and the triggering part are made of a metallic material.

6. The keyboard according to claim 1, wherein the keyboard further comprises a power-supplying circuit board, and the power-supplying circuit board is located beside at least one of the plural swinging-type key structures, wherein the power-supplying circuit board is electrically connected with the light-emitting element to provide electric power to the light-emitting element.

7. The keyboard according to claim 1, wherein there is a vacant space between every two adjacent light guide sub-plates of the plural light guide sub-plates to separate the two adjacent light guide sub-plates, so that the two light guide sub-plates are swung independently.

8. The keyboard according to claim 1, wherein the covering member further comprises:
an upper covering layer located over the light guide plate to cover the light guide plate, wherein the plural light-transmissible regions are formed in the upper covering layer; and
a lower covering layer located under the base plate to cover the base plate, wherein the lower covering layer and the upper covering layer are combined together.

9. The keyboard according to claim 8, wherein the light-transmissible regions are hollow structures that are formed by performing a laser-engraving process to remove a portion of the upper covering layer, and the upper covering layer is made of synthetic feather and foam, wherein the synthetic feather is polyurethane (PU) feather.

10. The keyboard according to claim 8, wherein the upper covering layer is made of light-transmissible thermoplastic polyurethane (TPU) material, and the light-transmissible regions and plural opaque region are formed on the upper covering layer by a local negative printing process, wherein the light beam is not allowed to pass through the plural opaque regions.
